(19) United States
(12) Patent Application Publication
(10) Pub. No.: US 2024/0364835 A1
(43) Pub. Date: Oct. 31, 2024

(54) READING APPARATUS, READING METHOD, AND MEDIUM

(71) Applicant: BROTHER KOGYO KABUSHIKI KAISHA, Nagoya (JP)

(72) Inventors: DAISUKE MATSUMOTO, Nagoya (JP); TAIGA MIZUMORI, Nagoya (JP); TOSHIKAZU HORI, Nagoya (JP); THANH NGUYENVAN, Nagoya (JP); TOSHIKI MOTOYAMA, Konan (JP); SATOSHI MATSUSHITA, Nagoya (JP); HIROYA NOJIRI, Nagoya (JP); SATORU YANAGI, Obu (JP); TOMOMI SHIRAKI, Nagoya (JP); AKIHITO UNO, Iwakura (JP)

(21) Appl. No.: 18/645,460

(22) Filed: Apr. 25, 2024

(30) Foreign Application Priority Data
Apr. 27, 2023 (JP) 2023-073698

(51) Int. Cl. H04N 1/44; H04N 1/00

(52) U.S. Cl. CPC H04N 1/4433; H04N 1/00204; H04N 1/00413; H04N 1/00811; H04N 2201/0081

(57) ABSTRACT

There is provided a reading apparatus including: a user interface; a communication interface; a scanner; and a controller configured to execute a first scan in response to an instruction to execute the first scan based on an operation to the user interface, and a second scan based on an instruction to execute the second scan from an external apparatus connected to the reading apparatus via the communication interface. The controller is configured to: execute the first scan without requiring authentication in a case where the controller receives, via the user interface, the instruction to execute the first scan; and perform the authentication in a case where the controller receives, via the communication interface, the instruction to execute the second scan, and then execute the second scan in a case where the authentication succeeds and not execute the second scan in a case where the authentication fails.

### REFERENCE TO RELATED APPLICATIONS

This application claims priority from Japanese Patent Application No. 2023-073698 filed on Apr. 27, 2023. The entire content of the priority application is incorporated herein by reference.

### BACKGROUND ART

There is a known reading apparatus which, in a case where an instruction of executing a scan (scan executing instruction) is received thereby, performs authentication of a user performed an operation corresponding to the scan executing instruction, and which starts scanning of a document (original document) in a case where the authentication succeeds. With this, the reading apparatus is capable of preventing a malicious third party from reading the document.

### SUMMARY

In a reading apparatus described in Japanese Patent Application Laid-open No. 2009-177547, in a case where the reading apparatus receives the scan executing instruction, the reading apparatus uniformly requests the authentication, thereby causing any inconvenience for users in some cases, and thus there is room for improvement. On the other hand, in a case where the scan is executed for all the users without requiring the authentication, there is a possibility that a scan by a malicious third party might be executed.

The present disclosure has been made in view of the above-described problem, and an object of the present disclosure is to provide a reading apparatus, a reading method, and a medium each of which is capable of balancing security and convenience for a user.

According to a first aspect of the present disclosure, there is provided a reading apparatus including:
a user interface;
a communication interface;
a scanner; and
a controller configured to execute a first scan of causing the scanner to read a document in response to an instruction to execute the first scan based on an operation to the user interface, and a second scan of causing the scanner to read a document in response to an instruction to execute the second scan from an external apparatus connected to the reading apparatus via the communication interface,
wherein the controller is configured to:
execute the first scan without requiring authentication in a case where the controller receives, via the user interface, the instruction to execute the first scan; and
perform the authentication in a case where the controller receives, via the communication interface, the instruction to execute the second scan, and then execute the second scan in a case where the authentication succeeds and not execute the second scan in a case where the authentication fails.

According to a second aspect of the present disclosure, there is provided a reading method executed by a controller of a reading apparatus including: a user interface, a communication interface, a scanner and the controller, the controller being configured to execute a first scan of causing the scanner to read a document in response to an instruction to execute the first scan based on an operation to the user interface, and a second scan of causing the scanner to read a document in response to an instruction to execute the second scan from an external apparatus connected to the reading apparatus via the communication interface,
the reading method including:
executing the first scan without requiring authentication in a case where the controller receives, via the user interface, the instruction to execute the first scan, and
performing the authentication in a case where the controller receives, via the communication interface, the instruction to execute the second scan, and then executing the second scan in a case where the authentication succeeds and not executing the second scan in a case where the authentication fails.

According to a third aspect of the present disclosure, there is provided a non-transitory and computer-readable medium storing a program executable by a controller of a reading apparatus including: a user interface, a communication interface, a scanner and the controller, the controller being configured to execute a first scan of causing the scanner to read a document in response to an instruction to execute the first scan based on an operation with respect to the user interface, and a second scan of causing the scanner to read a document in response to an instruction to execute the second scan from an external apparatus connected to the reading apparatus via the communication interface,
the program is configured to cause the controller to:
execute the first scan without requiring authentication in a case where the controller receives, via the user interface, the instruction to execute the first scan, and
perform the authentication in a case where the controller receives, via the communication interface, the instruction to execute the second scan, and then execute the second scan in a case where the authentication succeeds and not execute the second scan in a case where the authentication fails.

In the above-described configuration, in the first scan wherein the controller receives an instruction to execute reading of a document, by the operation of the user interface of the reading apparatus, a user is present on the side of the reading apparatus. Thus, there is a low possibility that the document might be read by a malicious third party, and the controller executes the reading of the document without requiring the authentication. On the other hand, in the second scan wherein the controller receives the instruction from the external apparatus, the user is capable of performing the instruction to read the document by the external apparatus which is located at a position far from the reading apparatus, and thus there is a possibility that the document might be read by a malicious third party. Accordingly, the authentication is required with respect to the instruction to execute the second scan, which in turn suppresses a lowering in security. With this, it is possible to balance the security and the convenience for a user.

According to the present disclosure, it is possible to provide a reading apparatus, a reading method, and a medium each of which is capable of balancing security and convenience for a user.

### BRIEF DESCRIPTION OF DRAWINGS

FIG. 1 is a view depicting a configuration of an MFP (Multi Function Peripheral).

FIG. 2 is a timing chart describing a process executed between a PC and the MFP.

FIG. 3 is a view describing a home screen displayed by a browser.

FIG. 4 is a view describing a restriction setting screen.

FIG. 5 is a diagram describing an SFL database.

FIG. 6 is a flowchart describing a process to be executed by a controller of the MFP.

FIG. 7 is a flowchart describing a process to be executed in S11 of FIG. 6;

FIG. 8 is a flowchart describing a process to be executed in S12 of FIG. 6.

FIG. 9 is a flowchart describing a process to be executed in S35 of FIG. 8.

FIG. 10 is a flowchart describing a process to be executed in S37 of FIG. 8.

FIG. 11 is a flowchart describing a process to be executed in S12 of FIG. 6.

FIG. 12 is a flowchart describing a process to be executed in S80 of FIG. 11.

### DESCRIPTION

### First Embodiment

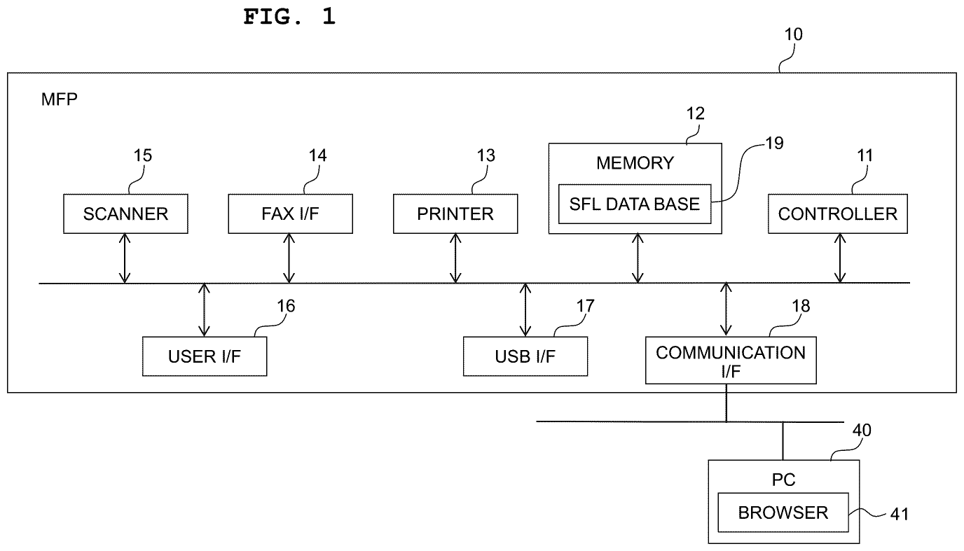

An embodiment of a reading apparatus will be described using an MFP (Multi Function Peripheral). As depicted in FIG. 1, a MFP 10 includes a controller 11, a memory 12, a printer 13, a FAX I/F 14, a scanner 15, a user I/F 16, a USB I/F 17, and a communication I/F 18. These components are communicatively connected to one another via a bus.

The communication I/F 18 connects the MFP 10 to a network. With this, the MFP 10 is capable of communicating, with a PC 40 connected to the network, via the network and according to a predetermined protocol. The scanner 15 has a reading sensor which is, for example, such as a CCD or CIS, and generates image data according to reading of a document (original document). The printer 13 prints an image on a recording medium such as a sheet, a disc, etc. The sheet is also referred to as a paper sheet. As a recording system of the printer 13, it is possible to adopt an ink-jet system, an electrophotographic system, etc.

The user I/F 16 is an interface which is capable of receiving a variety of kinds of operations, by a user, with respect to the MFP 10. The user I/F 16 includes a touch panel including a liquid crystal display, a variety of kinds of switches, etc. The USB I/F 17 reads into and writes out data in accordance with a USB standard with respect to a storage medium which is USB-compatible and removably connected to the USB I/F 17. The storage medium which is USB-compatible is, for example, a USB memory, etc. The communication I/F 18 is an interface which connects the MFP 10 to the network. The communication I/F 18 enables the MPF10 to perform wired LAN communication or wireless LAN communication between the MFP 10 and the PC 40.

The memory 12 is constructed by combining a volatile memory such as a RAM, a non-volatile memory such as a NVRAM, and a ROM, etc. An SSD, an HDD, etc. may be used as the non-volatile memory. A buffer which is provided on the controller 11 and which is used in a case of executing a variety of kinds of programs may also be considered as a part of the memory 12. Note that the memory 12 may be a storage medium readable by the controller 11. The storage medium readable by the controller 11 is a non-transitory medium. In addition to the above-mentioned examples of the non-transitory medium, the non-transitory medium also includes a recording medium such as a CD-ROM and a DVD-ROM, etc. Further, the non-transitory medium is also a tangible medium. On the other hand, an electrical signal which carries a program downloaded from a server on the Internet is a computer-readable signal medium as a kind of a computer-readable medium, but is not included in the storage medium which is non-transitory and computer-readable.

The memory 12 stores a firmware (not depicted in the drawings) as a program executable by the controller 11. The present embodiment mainly shows a process of the controller 11 according to an instruction written in a program. Namely, each of processes such as “determination (determine)”, “calculation (calculate)”, “specification (specify)”, “obtainment (obtain)”, “reception (receive)”, and “control”, etc., in the following description represents a process of the controller 11. Note that the process of “obtainment (obtain)” is used as a concept in which a request is not essential. Namely, a process in which the controller 11 receives data without requesting the data is also included in the concept that “the controller 11 obtains data”. Further, the term “data” in the present specification is represented by a bit string readable by the controller 11. Furthermore, one data and other data having a substantially same meaning and a content but having different formats are to be treated as same data. This also applies similarly to “information” in the present specification. That is, one information and other information having a substantially same meaning and a content but having different formats are to be treated as same information.

The controller 11 also functions as a Web server configured to display a predetermined Web page with respect to the PC 40. The controller 11 is capable of transmitting Web page data, with respect to the PC 40, for displaying a Web page to thereby cause a browser 41 (to be described later on) of the PC 40 to display the Web page. The controller 11 also functions as the Web server by executing a non-illustrated firmware.

Next, the configuration of the PC 40 will be described. The PC 40 includes a communication I/F, a memory, a controller, a display, and a user I/F (which are not depicted in the drawings). The memory of the PC 40 stores an OS and a browser 41. The browser 41 is capable of displaying on the display a Web page according to Web page data transmitted from the MFP 10. Note that the external apparatus is not restricted to the PC 40; the external apparatus may be a mobile terminal such as a smartphone, etc., under a condition that the external apparatus is an apparatus which is capable of transmitting or sending an instruction of executing a pull scan (pull scan executing instruction), which will be described later, to the MFP 10.

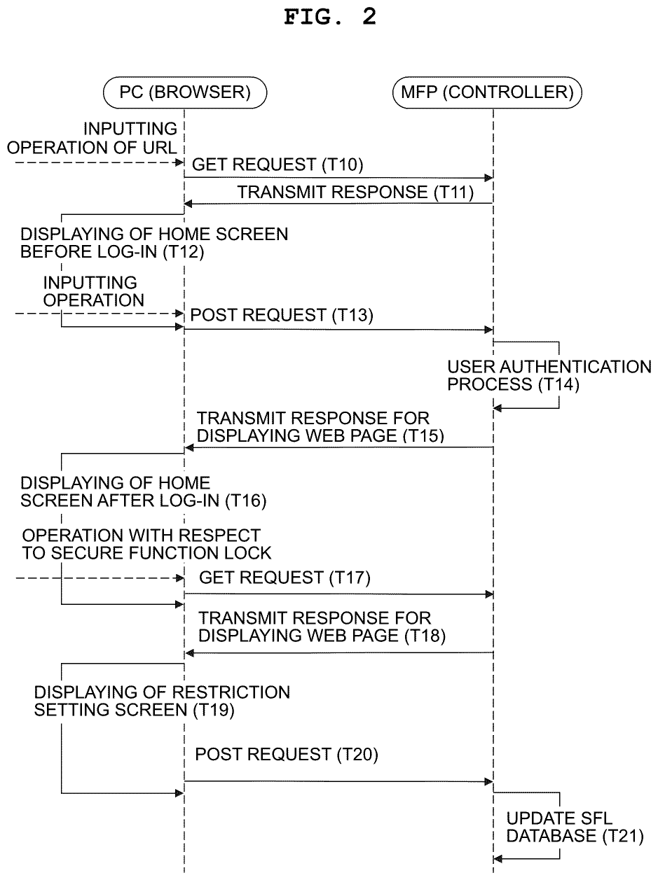

Next, a procedure of a process for setting restriction setting values regarding restrictions on functions of the MFP 10, respectively, by using the function of the controller 11 as a Web server, will be described with reference to FIG. 2. The user operates the PC 40 so as to input, into the browser 41, a URL for specifying the Web server of the MFP 10. The browser 41 transmits a GET request of a HTTPS communication including the inputted URL, at timing 10 (hereinafter, the timing is also referred to as “T”). In a case where the controller 11 receives the GET request from the browser 41, the controller 11 transmits an HTTPS response corresponding to the GET request.

The response returned at T11 includes Web page data for displaying a home screen before a log-in. In a case where the browser 41 receives the Web page data, the browser 41 uses the Web page data so as to display the home screen before the log-in on the display, at T12. Note that the details of the home screen will be described later on.

The user enters a log-in password in a password input field on the home screen, whereby the browser 41 transmits a POST request including the log-in password to the controller 11 at T13. In a case where the controller 11 receives the POST request including the log-in password, the controller 11 performs, at T14, a user authentication process using the log-in password included in the POST request.

In the user authentication process executed at T14, the controller 11 determines as to whether or not the inputted password included in the POST request matches a registered log-in password. The controller 11 compares the inputted password included in the POST request with the registered password which has been registered, and allows the user authentication with respect to the MFP 10 in a case where the two passwords match completely. In addition to this, the controller 11 also may allow the user authentication with respect to the MFP 10 in a case where the inputted password and the registered password match partially.

In the case where the inputted password matches the registered password in the user authentication process at T14, the controller 11 generates a response for a case wherein the user authentication process succeeds. This response includes Web page data for displaying a home screen after log-in which is a Web page.

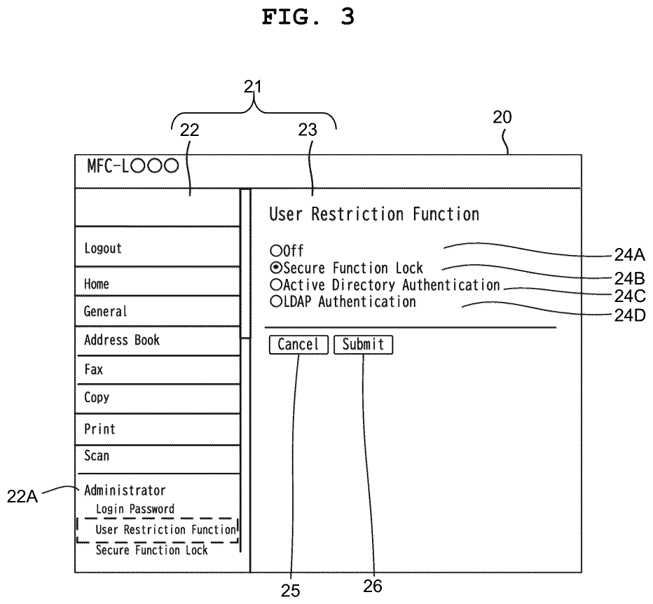

At T15, the controller 11 transmits a response to the browser 41 in order to cause the home screen after the log-in to be displayed. In a case where the browser 41 receives the response, the browser 41 causes the user I/F 16 to display a home screen 20 after the log-in which is a Web page, at T16. The home screen 20 after the log-in depicted in FIG. 3 includes a page display field 21 which is constructed of an item part 22 and a content display part 23. The item part 22 is a part at which icons each receiving one of selection operations of various functions of the MFP 10 are displayed. In addition to this, a URL display field configured to display a URL of a registered site may be included at a location above the page display field 21.

In a case where a selecting operation is performed on any one of the icons in the item part 22, the browser 41 transmits, to the controller 11, a GET request of requesting Web page data corresponding to the selected icon. The controller 11 transmits a response including the Web page data to the PC 40 in accordance with the request. With this, the browser 41 is capable of causing the content display part 23 to display the Web page corresponding to the selected item. Note that instead of the configuration wherein the controller 11 transmits the Web page data as the response to the browser 41, it is acceptable to provide such a configuration wherein the controller 11 transmits, to the browser 41, only data indicating a screen to be displayed on the content display part 23, and the browser 41 changes a content displayed on the content display part 23 by using the data.

This example depicts a state that the user has selected a “User Restriction Function” which is one of icons in an icon 22A “Administrator” in the item part 22 on the home screen 20 after the log-in. The “User Restriction Function” is a function of setting a setting value regarding a restriction with respect to a user who uses the MFP 10. The setting value regarding the restriction may also be considered as a setting value regarding a permission. The content display part 23 includes a check box 24A “Off”, a check box 24B “Secure Function Lock”, a check box 24C “Active Directory Authentication” and a check box 24D “LDAP Authentication” each of which is configured to receive one of detailed setting instructions regarding the function of “User Restriction Function”.

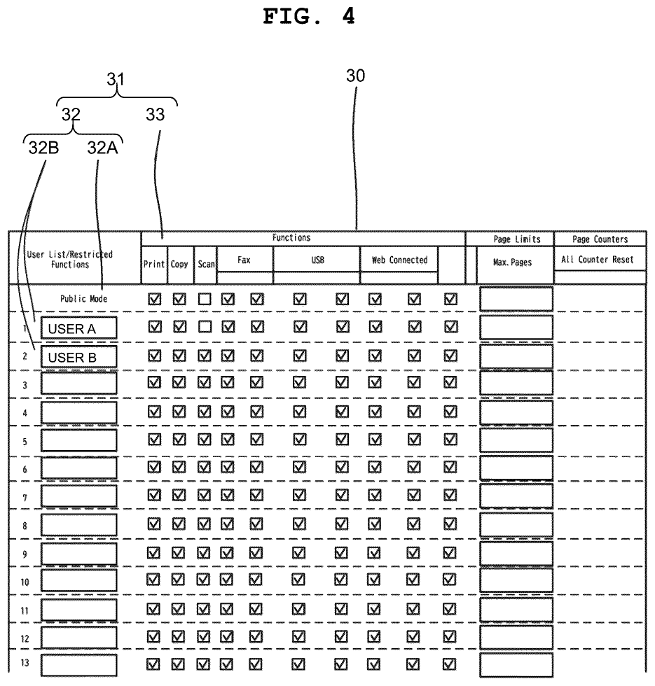

In a case where the user checks the checkbox 24A of the item “Off” displayed on the content display part 23, an invalidating setting of the function “User Restriction Function” is designated, whereas in a case where the user does not check the checkbox 24A but checks another checkbox different from the checkbox 24A, a validating setting of the function “User Restriction Function” is designated. The item “Secure Function Lock” is an item for receiving a restriction setting for each of the functions of the MFP 10 for each of the users. In the following, the “Secure Function Lock” will also be referred to as “SFL”. In a case where the user checks the checkbox 24B of the “SFL”, this allows the user to set restriction setting values each of which indicates a restriction of one of the respective functions, by using a restriction setting screen 30 depicted in FIG. 4 (to be described later on).

In a case where the user checks the checkbox 24B of the “SFL” included in the content display part 23 of the home screen 20 and operates a submit button (approval button) 26, the browser 41 transmits, at T17, a GET request of requesting the MFP 10 of Web page data for causing the restriction setting screen 30 depicted in FIG. 4 to be displayed on the content display part 23. In a case where the MFP 10 receives the GET request from the PC 40, the MFP 10 transmits, at T18 to the PC 40, response data including Web page data of causing the browser 41 to display the restriction setting screen 30. Note that in a case where the user operates the PC 40 and operates a cancel button 25 on the home screen 20, the input made to the content display part 23 on the home screen 20 is canceled.

In a case where the browser 41 receives the response data from the MFP 10, the browser 41 displays, at T19, the restriction setting screen 30 depicted in FIG. 4. The restriction setting screen 30 includes a restriction designation field 31 configured to receive a designation of a user and a function which are to be objects (targets) of the restriction in the above-described function “SFL”. Further, the restriction designation field 31 includes a user designation items 32 (32A, 32B) configured to designate users as objects of the restriction, and a function designation item 33 configured to designate functions as objects of the restriction. Note that respective values on the restriction setting screen 30 correspond to registered contents of the SFL database 19 stored in the memory 12 of the MFP 10.

Among the user designation items 32, an item 32A of “Public Mode” is an item configured to designate a state of being not logged in (a state that any user is not logged in; a no log-in state), as an object of the function “SFL”. The item 32A of the “Public Mode” can also be considered as being an item configured to set a restrictions without specifying the user. Among the user designation items 32, an item 32B of individual users is an item configured to designate an inputted user, namely, a specific user, to be an object of the function “SFL”.

The function designation item 33 is an item configured to receive a designation of a function for which a restriction is to be set by the function “SFL”. In the restriction setting screen 30 depicted in FIG. 4 and in the function designation item 33, check boxes indicating presence or absence of the restriction setting are displayed corresponding, respectively, to the functions of the MFP 10 which are, for example, “Print”, “Copy”, “Scan”, “FAX”, “USB” and “Web Connection”. Note that the function “Scan” corresponds to a push scan which will be described later on. In the function designation item 33, a checked function, among the functions, is a function which is designated that any restriction is not set therefor, whereas an unchecked function, among the functions, is a function which is designated that a restriction is set therefor. Although not depicted in the drawings, the function “FAX” includes individual functions which are “FAX transmission” and “FAX reception”, and there is a check box for each of the individual functions. The function “USB” includes individual functions which are “USB direct print” and “Scan to USB”, and there is a check box for each of the individual functions. The function “Web connection” includes individual functions which are “upload” and “download”, and there is a check box for each of the individual functions.

Note that in the function designation item 33, in addition to the restrictions on the above-described respective functions, there are also functions which are, for example, a function “Page Limits” configured to designate an upper limit on the number of pages which can be printed, and/or a function “Page Counters” configured to indicate a cumulative number of pages printed in a state that the user is not logged in or printed for each of the users.

For example, among the user designation items 32, in the function designation item 33 related to the item 32A “Public Mode”, only the function “Scan” is unchecked, and the other functions which are different from the scan “Function” are checked. Therefore, it is indicated that in a case where no one is logged in to the MFP 10, the execution of the function “Scan” is restricted, but the executions of the other functions different from the scan “Function” are not restricted. Similarly, in the function designation item 33 related to a “User A” in the individual user items 32B, only the function “Scan” is not checked, but the other functions different from the function “Scan” are checked. Therefore, it is indicated that in a case where the “User A” logs in, the execution of the function “Scan” is restricted, but other functions are not restricted. In the function designation item 33 related to a “User B” of the individual user items 32B, all functions are checked. Therefore, it is indicated that in a case where the “User B” logs in, there are no restrictions on the execution of all functions, including the function “Scan”.

In a case where a user operates a non-illustrated confirmation button in a state that the restriction setting screen 30 is displayed on the home screen 20, the browser 41 transmits, at T20, information “ON” indicating that the function “SFL” is valid and a POST request including contents of the respective restriction setting values designated on the restriction setting screen 30, to the MFP 10. In a case where the controller 11 receives the information “ON” indicating that the function “SFL” is valid and the POST request including the designated contents of the respective restriction setting values, the controller 11 updates, at T21, contents of the SFL database 19 stored in the memory 12.

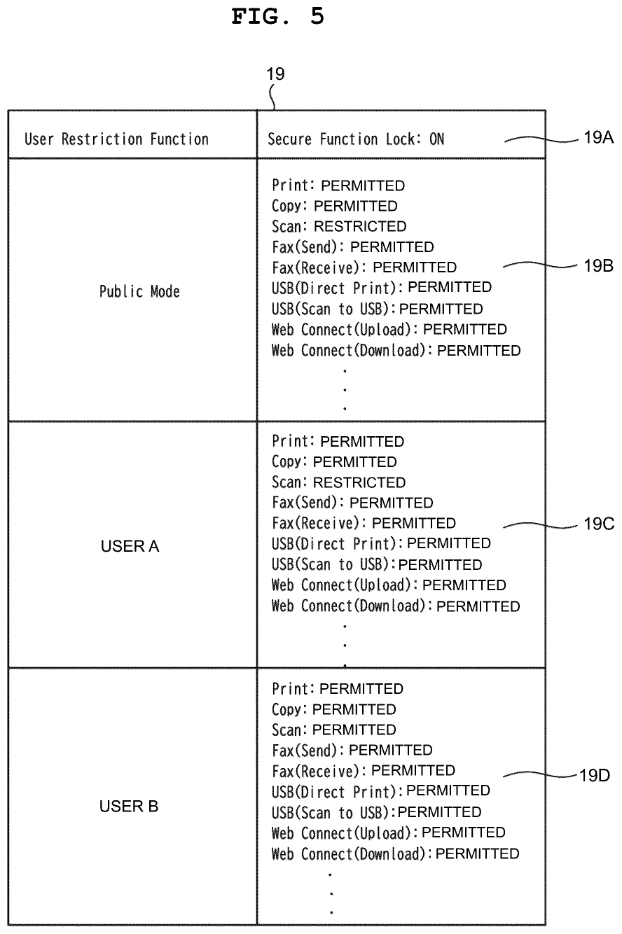

FIG. 5 depicts a part of the SFL database 19 updated by using the designated contents of the restriction setting values designated on the restriction setting screen 30 depicted in FIG. 4. In FIG. 5, a restriction setting value “ON” indicating that the function “SFL” is valid is registered in a first column 19A. In a column 19B, restriction setting values with respect to the respective functions are registered, with the “Public Mode”, namely, the state that any user is not logged in, as the object of the restriction. Specifically, in the column 19B, a restriction setting value “Restricted” indicating that the function “Scan” is restricted, namely, the execution of the function “Scan” is not valid is registered. Similarly, in a column 19C, restriction setting values with respect to the respective functions are registered for the “User A” as the object of the restriction, and a restriction setting value “Restricted” indicating that the function “Scan” is restricted is registered. In a column 19D, restriction setting values with respect to the respective functions are registered for the “User B” as the object of the restriction, and a restriction setting value “Permitted” indicating that there is no restriction regarding the function “Scan”, namely that the execution of the function “Scan” is valid is registered. The phrase that the execution is valid can be also considered as the execution is permitted.

Next, a description will be given regarding a procedure of a process to be executed by the controller 11 in a case where the user uses the function “Scan” of the MFP 10. The MFP 10 is configured to execute a “push scan” and a “pull scan”, as the function “Scan”. The “push scan” is a scan in which the scanner 15 is caused to read a document (original document) in accordance with an executing instruction according to an operation by the user with respect to the user I/F 16. The “pull scan” is a scan in which the scanner 15 is caused to read a document (original document) in accordance with an operation with respect to an external apparatus connected to the scanner 15 via the communication I/F 18 and by an executing instruction received from the external apparatus. In the present embodiment, the external apparatus is the PC 40. In the present embodiment, the “push scan” is an example of a “first scan”, and the “pull scan” is an example of a “second scan”.

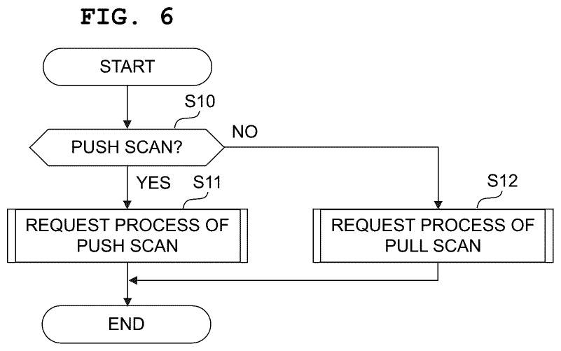

FIG. 6 is a flowchart describing the process to be executed by the controller 11 in a case where the user uses the function “Scan”. First, in step 10, the controller 11 determines as to whether or not the controller 11 has received an instruction of executing the scan by the user I/F 16, namely, an instruction of executing the push scan. In the following, a step will also be referred to as “S”. Specifically, in a case where the controller 11 has received the instruction of executing the function “Scan” by the operation with respect to the user I/F 16 of the MFP 10, the controller 11 determines that the instruction of executing the push scan has been received (S10: YES), and proceeds to S11. Note that in response to the reception of the operation with respect to the user I/F 16, the controller 11 transmits a request of the push scan to the external apparatus (in this example, the PC 40). The external apparatus which has received the request returns an instruction of executing the function “Scan” to the MFP 10. In a case where the controller 11 has received this reply, the controller 11 determines that the executing instruction of the push scan has been received. In a case where the controller 11 has received the executing instruction transmitted from the external apparatus in accordance with the operation in the external apparatus, the controller 11 determines that the executing instruction of the pull scan has been received (S10: NO), and proceeds to S12.

Note that the executing instruction of the “Scan” may include information indicating whether the executing instruction is in response to the reception of the operation with respect to the user I/F 16 or the executing instruction is in response to the operation in the external apparatus; and the controller 11 may determine whether the instruction is the executing instruction of the push scan or the executing instruction of the pull scan, based on the information. In response to the reception of the operation with respect to the user I/F 16, the controller 11 may determine that the executing instruction of the push scan has been received, without transmitting the request to the external apparatus, and may proceed to S11.

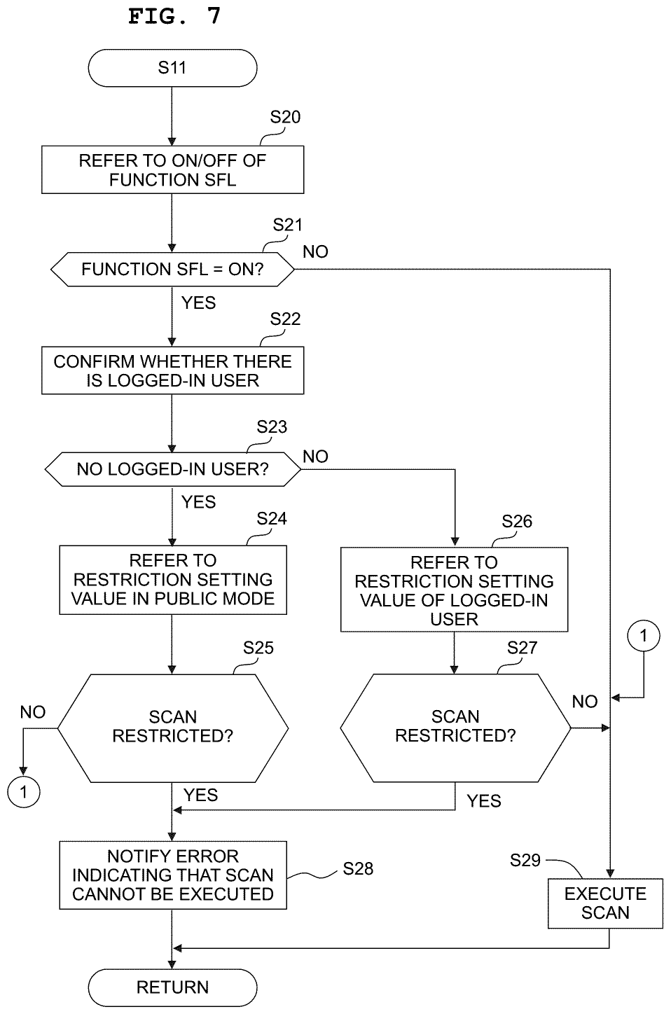

A description will be given about a procedure of restricting the push scan in accordance with the restriction setting value registered in the SFL database 19 in S11, in a case where the controller 11 receives the executing instruction of the push scan via the user I/F 16 (S10: YES). FIG. 7 is a flowchart describing the procedure of a requesting process of the push scan executed by the controller 11 in S11.

First, a description will be given about a process in a state that any log-in is not performed with respect to the MFP 10. For the sake of the convenience, the state that any log-in is not performed with respect to the MFP 10 is also referred to as the “Public Mode”. In S20, the controller 11 refers to the “ON” which indicates that the function “SFL” is validated, or the “OFF” which indicates that the function “SFL” is invalidated, and which is registered in the column 19A of the SFL database 19 stored in the memory 12.

In a case where the controller 11 determines that the function “SFL” is invalidated (S21: NO), the controller 11 proceeds to S29 and executes a scan process of causing the scanner 15 to read the document set in a document table. Namely, the controller 11 executes the process without setting any restrictions on the push scan, and ends the process in FIGS. 6 and 7.

In this example, the restriction setting value indicating whether the function “SFL” is validated or invalidated is the validated “ON” in the SFL database 19 depicted in FIG. 5, and thus the controller 11 determines that the function “SFL” is validated (S21: YES). Then, the controller 11 proceeds to S22 and confirms whether or not there is a logged-in user who is logged in to the MFP 10 by operating the user I/F 16. In this example, since there is provided such a state that any user is not logged in to the MFP 10 (S23: YES), the controller 11 proceeds to S24 and refers to the restriction setting value corresponding to the function “Scan” in the “Public Mode” in the SFL database 19.

Since the restriction setting value corresponding to the function “Scan” in the “Public Mode” is “Restricted” in the SFL database 19 (S25: YES), the controller 11 proceeds to S28 and notifies an error indicating that the execution of the function “Scan” is not possible. In the present embodiment, the controller 11 performs the notification of the error by causing the user I/F 16 to display an error screen indicating that the execution of the function “Scan” is not possible. Namely, the controller 11 sets the restriction with respect to the push scan in the state that any user is not logged in (the no log-in state). In the present embodiment, the phrase “the restriction with respect to the function “Scan” means that the scan process is not executed. The controller 11 ends the processes in FIGS. 6 and 7.

Next, a process in a case where a “User A” is logged in to the MFP 10 will be described. Since the “User A” is logged in (S23: NO), the controller 11 refers to the restriction setting value corresponding to the function “Scan” for the user A in the SFL database 19 in S26. As depicted in FIG. 5, in the column 19C, the restriction setting value corresponding to the function “Scan” for the “User A” is set to “Restricted”. Since the restriction setting value corresponding to the function “Scan” for the user A, who is the logged-in user, indicates the restriction setting value of “Restricted” (S27: YES), the controller 11 proceeds to S28. In S28, the controller 11 notifies the error indicating that the scan cannot be executed, as described in the foregoing, and ends the processes of FIGS. 6 and 7.

Next, a process in a case where a “User B” is logged in to the MFP 10 will be described. Since the restriction setting value “ON” by which the function “Scan” is not restricted is registered for the “User B” in the SFL database 19 (S27: NO), the controller 11 proceeds to S29 and executes the scan process (push scan). Namely, the controller 11 executes the push scan without imposing any restriction.

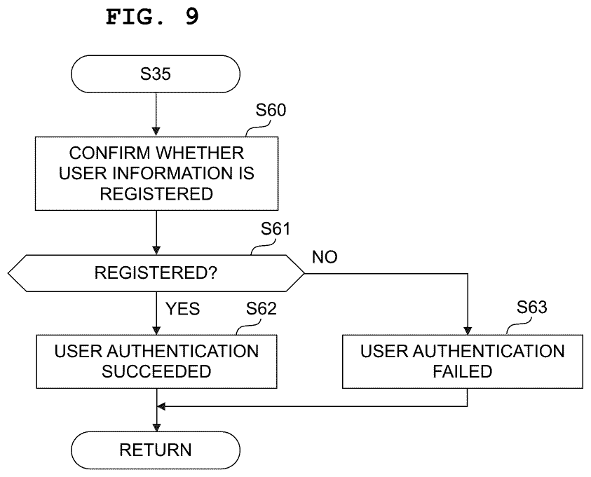

Here, the term “log-in” will be described. User information of the “User A” and user information of the “User B” are registered in the SFL database 19. The user information includes a user ID and a password corresponding to the user ID. In a case where a user ID and a password corresponding to the user ID which are registered in the SFL database 19 are inputted via the user I/F 16 by a log-in process, the controller 11 performs the variety of kinds of processes, presuming that the MFP 10 is in the log-in state corresponding to the inputted user information. For example, in a case where a user ID “User A” and a corresponding password are inputted, the controller 11 performs the variety of kinds of processes, presuming that the MFP 10 is in the log-in state corresponding to the inputted “User A”. The user information registered in the SFL database 19 can also be considered to be user information of a user who is permitted to log in to the MFP 10. Note that the log-in state corresponding to the user information is also referred to as the state that the user indicated by the user information is logged in. Further, the log-in state corresponding to the “User A” is also referred to as the state that the “User A” is logged in. Furthermore, in a case where the user indicated by the user information is in the log-in state, the user indicated by the user information is also referred to as a “log-in user (logged-in user)”. Note that the inputting of the user ID and the password in the log-in process may also be performed by bringing an ID card corresponding to the user ID registered in the SFL database 19 closely to or in contact with the MFP 10. Further, the information used for the log-in process may be stored in an area which is different from the SFL database 19 in the memory 12. In this case, the controller 11 may refer to this area in the memory 12 in the log-in process and in the process of FIG. 9.

Next, a description will be given about a process executed by the controller 11 in a case where the instruction of executing the pull scan is received from the PC 40, by the operation of the PC 40 by the user. First, a description will be given about a process executed in a case where the “User A” operates the PC 40 so as to execute the pull scan in a state that any log-in is not performed with respect to the MFP 10, namely, in the “Public Mode”.

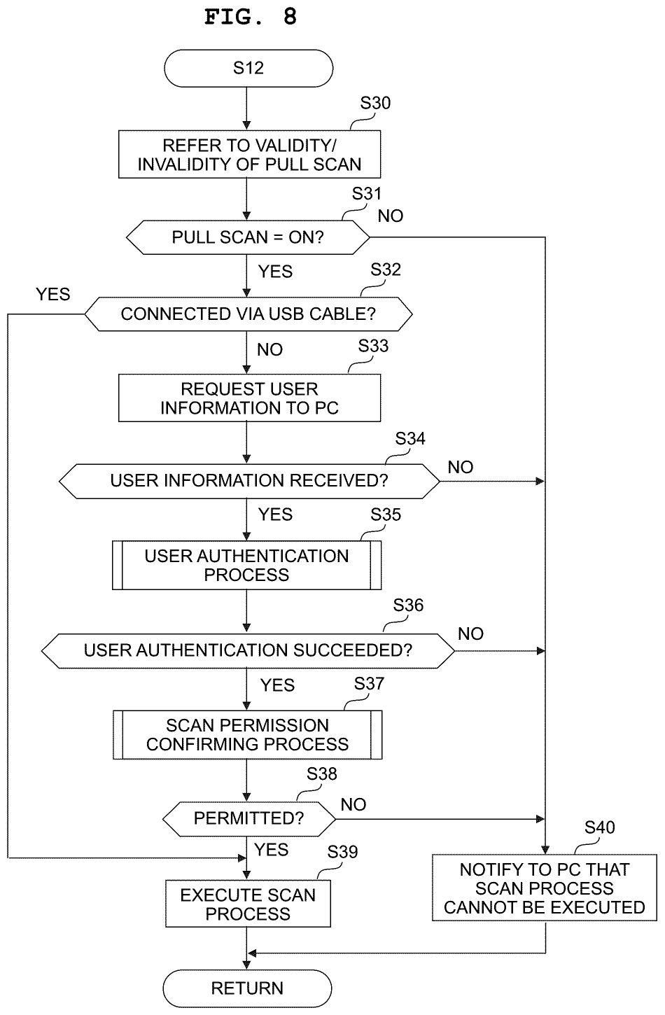

Since the controller 11 has received the scan executing instruction from the PC 40, namely, the executing instruction of the pull scan (S10: NO), the controller 11 proceeds to S12 and performs the requesting process of the pull scan. FIG. 8 is a flowchart describing the procedure of the process executed by the controller 11 in S12. In S30, the controller 11 determines as to whether the execution of the pull scan is set to be validated or invalidated in the MFP 10. In this example, it is presumed that the pull scan is validated (S31: YES), and the controller 11 proceeds to S32 and determines as to whether the executing instruction of the pull scan is received from the PC 40 connected, to the MFP 10, via the USB cable. Here, presuming that the PC 40 and the MFP 10 are connected via a network which is different from the USB cable (S32: NO), the controller 11 proceeds to S33.

Note that in a case where the pull scan is set to be invalidated in the MFP 10 (S31: NO), the controller 11 proceeds to S40 and notifies the PC 40 that the pull scan cannot be executed. Namely, in a case where pull scan is set to be invalidated in MFP 10, the pull scan will not be executed regardless of which user is logged in to MFP 10. Information indicating whether pull scan is set to be validated or invalidated is stored in the memory 12, separately from the SFL database 19. Further, in a case where the PC 40 and the MFP 10 are connected by the USB cable and where the executing instruction of executing the pull scan is received via the USB cable (S32: YES), the controller 11 proceeds to S39 and executes the scan process. In the present embodiment, the controller 11 transmits the data read by the scanner 15 to the PC 40 in the scan process in S39. Namely, in the case where the MFP 10 and the PC 40 are connected by the USB cable, the user operating the PC 40 is present on the side of the MFP 10, and therefore there is a low possibility that the user operating the PC 40 might be a malicious third party. Therefore, in such a case, a user authentication process in S35, which will be described later on, is not required. Note that in the scan process in S39, the controller 11 may be configured to execute a copy by which a printer 13 is caused to print the data read by the scanner 15. In addition to this, in a case where a USB memory is connected via the USB I/F 17, the controller 11 may be configured to accumulate and save data read by the scanner 15 in the USB memory in the scanning process in S39.

The controller 11 performs, in S33, a GET request, with respect to the PC 40, so as to request the user information necessary for user authentication. In a case where the PC 40 has received the request for the user information from the MFP 10, the PC 40 transmits response data including the user information of the user operating the PC 40 to the MFP 10. Specifically, the user information is the user ID and the password. In this case, the PC 40 transmits response data including user information of “User A”. The PC 40 may transmit response data including user information of a user who is logged in to the PC 40. The PC 40 may transmit response data including user information which has been inputted in the case where the user logged in to the PC 40.

Note that in a case where the PC 40 does not transmit the user information in response to the GET request from the MFP 10, the user authentication process in S35, which will be described later on, cannot be executed. Therefore, in a case where the controller 11 does not receive the user information from the PC 40 (S34: NO), the controller 11 proceeds to S40 and notifies the PC 40 that the scan process (pull scan) cannot be executed.

Here, it is presumed that the controller 11 has received the user information from the PC 40 (S34: YES), and the controller 11 proceeds to S35 and executes the user authentication process. FIG. 9 is a flowchart describing the procedure of the process executed by the controller 11 in S35. First, in S60, the controller 11 confirms whether or not the user information received from the PC 40 (in this example, information indicating the “User A”) is registered in the SFL database 19 as information used for the log-in process. As depicted in FIG. 5, at least the user information regarding the “User A” and the user information regarding the “User B” are registered in the SFL database 19.

Since the user information received from the PC 40, namely, the user ID and the password, is registered in the SFL database 19 (S61: YES), the controller 11 proceeds to S62 and sets that the user authentication has succeeded. For example, the controller 11 sets an authentication flag indicating whether or not user authentication succeeds to a value indicating a success.

Note that, in S61, in a case where the user information received from the PC 40 is not registered in the SFL database 19 (S61: NO), the controller 11 proceeds to S63 and sets that the user authentication has failed. The controller 11 sets the authentication flag to a value indicating a failure. Then, since the user authentication has failed in S36 of FIG. 8 (S36: NO), the controller 11 proceeds to S40 and notifies the PC 40 that the scan process cannot be executed.

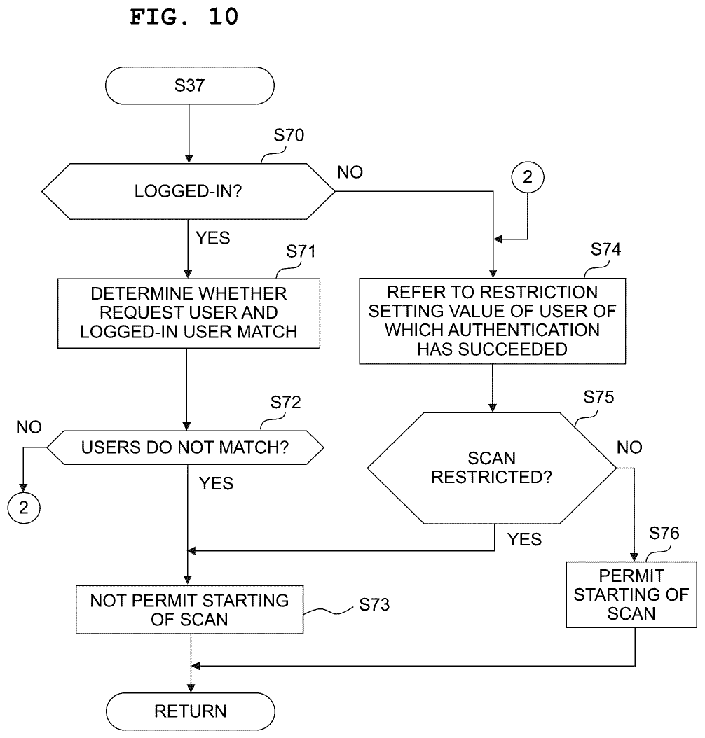

In this example, since the user authentication succeeds in S36 of FIG. 8 (S36: YES), the controller 11 proceeds to S37 and executes a scan permission confirming process. FIG. 10 is a flowchart describing the procedure of the process executed by the controller 11 in S37.

In S70, the controller 11 determines whether or not the MFP 10 is in the logged-in state, namely, whether or not the MFP 10 is in the “Public Mode”. In this example, since the MFP 10 is in the “Public Mode” (S70: NO), the controller 11 proceeds to S74.

In S74, the controller 11 refers to the restriction setting value of the function “Scan” with respect to the user of which user authentication in S35 as described above has succeeded. In this example, in the column 19C of the SFL database 19, the restriction setting value “Restricted” indicating the restriction of the function “Scan” corresponding to “User A” is registered. Therefore, since the function “Scan” is restricted with respect to the “User A” in S75 (S75: YES), the controller 11 proceeds to S73 and sets a flag indicating that a start of scanning is not permitted.

In S38 of FIG. 8, since the flag indicating that the start of the scanning is not permitted is set, namely, since the scan process is not permitted (S38: NO), the controller 11 proceeds to S40 and notifies to the PC 40 that the pull scan cannot be executed. Since the restriction of the push scan is set with respect to the “User A”, the controller 11 restricts the pull scan even in a case where authentication in the user authenticating process in S35 succeeds. Then, the controller 11 ends the process of FIG. 8.

Next, a description will be given about a process in which, the “User A” is in the logged-in state to the MFP 10, and the “User A” operates the PC 40 so as to execute the pull scan. Also in this example, the controller 11 executes the processes of S30 to S35 in FIG. 8 which have already been described. The controller 11 executes the scan permission confirming process in S37, under a condition that the user authentication has succeeded (S36: YES).

Since the “User A” is in the logged-in state to the MFP 10 in S70 in FIG. 10 (S70: YES), the controller 11 proceeds to S71 and determines whether or not a user requesting the pull scan matches the logged-in user. Specifically, the controller 11 compares the user information used in the user authentication process of S35, as described in the foregoing, with the user information of the logged-in user, to thereby determine whether or not the users match. Namely, the controller 11 determines whether or not the user operating the PC 40 and requesting the start of the pull scan matches the user logged in to the MFP 10.

In a case where the controller 11 determines that the users match (S72: NO), the controller 11 proceeds to S74. In S74, the controller 11 determines whether or not the restriction of the function “Scan” is set with respect to the user of which user authentication in S35 succeeded. Since the function “Scan” is restricted with respect to the “User A”, of which authentication has succeeded, in the SFL database 19 (S75: YES), the controller 11 proceeds to S73 and does not permit the start of the scan process (pull scan). The controller 11 proceeds to S38 in FIG. 8, and, as described in the foregoing, since the scan process is not permitted (S38: NO), the controller 11 proceeds to S40 and notifies the PC 40 that the pull scan cannot be executed.

Note that in a case where the controller 11 determines in S72 of FIG. 10 that the users do not match (S72: YES), the controller 11 proceeds to S73 and does not permit the start of the scan process (pull scan). Therefore, since the scan process is not permitted (S38: NO), in FIG. 8, the controller 11 proceeds to S40 and notifies the PC 40 that the pull scan cannot be executed.

Next, a description will be given about a process to be executed in a case where the “User B” operates the PC 40 so as to execute the pull scan in the state of “Public Mode” in which any user is not logged in to the MFP 10. The controller 11 performs the user authentication process with respect to the “User B” in S35; under a condition that the user authentication succeeds (S36: YES), the controller 11 executes the scan permission confirming process in S37.

Since the MFP 10 is in the “Public Mode” in S70 of FIG. 10 (S70: NO), the controller 11 proceeds to S74. In S74, the controller 11 refers to the restriction setting value corresponding to the function “Scan process” in the SFL database 19 with respect to the “User B” as a user of which authentication has succeeded. In this example, in the column 19D of the SFL database 19, the restriction setting value of “Permitted” is registered as the restriction setting value corresponding to the function “Scan” with respect to the “User B”. Therefore, since the function “Scan” is not restricted with respect to the “User B” (S75: NO), the controller 11 proceeds to S76 and sets a flag indicating that the start of scanning is permitted.

In S38 of FIG. 8, since the flag indicating the start of the scan is permitted is set, namely, the scan process is permitted (S38: YES), the controller 11 proceeds to S39 and performs the scan process (pull scan). Namely, since no restriction is set for the push scan with respect to the “User B”, the controller 11 executes the pull scan with respect to the “User B” under a condition that the authentication of the “User B” succeeds. Then, the controller 11 ends the process of FIG. 8.

Next, a description will be given about a process executed in a case where the “User B” operates the PC 40 so as to execute the pull scan in a state that the “User B” is logged in to the MFP 10. In S35, the controller 11 executes the user authentication process as described in the foregoing. Then, under a condition that the user authentication of the “User B” succeeds (S36: YES), the controller 11 executes the scan permission confirming process in S37. Since the “User B” is in the logged-in state in S70 in FIG. 10 (S70: YES), the controller 11 proceeds to S71 and determines as to whether or not the user operating the PC 40 to request the pull scan and the user which is logged in to the MFP 10 match.

In a case where the controller 11 determines that the users match (S72: NO), the controller 11 proceeds to S74 and determines whether or not the restriction of the function “Scan process” is set with respect to the user of which authentication has succeeded. As described in the foregoing, since the restriction setting value corresponding to the function “Scan” with respect to the “User B” is “Permitted” in the SFL database 19, (S75: NO), the controller 11 proceeds to S76 and permits the start of the scan process (pull scan). The controller 11 proceeds to S38 in FIG. 8, and since the scan process is permitted as described above (S38: YES), the controller 11 proceeds to S39, executes the pull scan, and ends the process in FIG. 8.

Note that in a case where the controller 11 determines in S72 of FIG. 10 that the users do not match (S72: YES), the controller 11 proceeds to S73 and does not permit the start of the scan process (pull scan). In other words, even in a case where the user authentication for the “User B” succeeds and the restriction setting value corresponding to the function “Scan” with respect to the “User B” is “Permitted” in the SFL database 19, if the users do not match, the controller 11 does not permit the pull scan. Therefore, since the scan process is not permitted in FIG. 8 (S38: NO), the controller 11 proceeds to S40 and notifies the PC 40 that the pull scan cannot be executed.

The present embodiment as described in the foregoing is capable of achieving the following effects.

In a case where the controller 11 receives the executing instruction of the push scan by the operating of the user I/F 16 of the MFP 10, the user is present on the side of the MFP 10, and thus there is a low possibility that the reading of the document might be instructed by a malicious third party. Accordingly, the controller 11 executes the push scan, without requiring the authentication. On the other hand, in a case where the controller 11 receives the executing instruction of the pull scan from the PC 40 connected to the MFP 10 via the communication I/F 18, the controller 11 performs the authentication. In a case where the authentication succeeds, the controller 11 executes the pull scan, whereas in a case where the authentication fails, the controller 11 does not perform the pull scan. In a case where the controller 11 receives the executing instruction of reading the document from the PC 40 located far from the MFP 10, there is a possibility that the executing instruction might be from a malicious third party. Accordingly, by requiring the authentication, the controller 11 suppresses any lowering in the security. This makes it possible to balance the security and the user convenience.

In a case where the controller 11 receives the executing instruction of the pull scan from the PC 40, the controller 11 requests the authentication information to the PC 40, and performs the user authentication process by using the authentication information obtained from the PC 40. With this, it is possible to reduce the possibility of the malicious third party operating the PC 40 and reading the document.

In a case where the controller 11 receives the executing instruction of the push scan via the user I/F 16, and where the restriction setting value registered in the SFL database 19 indicates the restriction of the push scan, the controller 11 restricts the push scan in accordance with the restriction setting value. With this, even in the push scan which does not require the authentication, in a case where the restriction is set therefor, the restriction on the push scan is imposed. By doing so, it is possible to prevent the security with respect to the MFP 10 from being excessively lowered.

In a case where the restriction setting value “Permitted” is registered with respect to the push scan of the user indicated by the user information in the SFL database 19 and where the condition for succeeding the user authentication is satisfied, the controller 11 executes the pull scan. On the other hand, in a case where the restriction setting value “Restricted” is registered with respect to the push scan of the user indicated by the user information, the controller 11 imposes the restriction upon the pull scan, namely, the controller 11 does not execute the push scan, even in a case where the condition for succeeding the user authentication is satisfied. With this, in a case where the restriction of the scan is set with respect to a specific user, the restriction is imposed upon the pull scan, even in a case where the authentication succeeds with respect to the specific user. By doing so, it is possible to prevent the security from being excessively lowered.

In a case where the controller 11 receives the executing instruction of the pull scan from the PC 40 connected to the MFP 10 via the USB cable, the controller 11 executes the pull scan without requiring the user authentication. In a case where the MFP 10 and the PC 40 are connected via the USB cable, the user performs an operation which corresponds to the executing instruction of the pull scan, with respect to the PC 40, on the side of the MFP 10. Therefore, there is a low possibility that the reading of the original might be instructed by the malicious third party, and the controller 11 is configured not to require the authentication regarding such a case.

### Modification of First Embodiment

The controller 11 of the MFP 10 may not execute the scan permission confirming process in S37 of FIG. 8. In this case, in a case where the controller 11 receives the executing instruction of the pull scan from the PC 40 and where the user authentication succeeds in S36 (S36: YES), the controller 11 proceeds to S39 and executes the pull scan. On the other hand, in a case where the controller 11 receives the executing instruction of the pull scan from the PC 40 and where the user authentication fails in S36 (S36: NO), the controller 11 proceeds to S40 and notifies the PC 40 that the pull scan cannot be executed.

### Second Embodiment

Regarding a second embodiment, a description will be given mainly about the configuration of the second embodiment which is different from that of the first embodiment. In the second embodiment, a location or part being a same as that in the first embodiment is denoted by a same reference numerals as that in the first embodiment and any description thereof will not be repeated. In the above-described embodiment, in a case where the controller 11 has received the executing instruction of executing the pull scan from the PC 40, the controller 11 uniformly executes the user authentication process in S35. Instead of this, the controller 11 may not require the user authentication in the pull scan, in a case where the restriction setting value “Permitted” is registered, in the SFL database 19, regarding the function “Scan” in the “Public Mode”, namely, regarding the push scan in the state that any user is not logged in. In other words, in the second embodiment, in a case where the restriction setting value “Restricted” is registered with respect to the function “Scan” in the “Public Mode”, namely, with respect to the push scan in the state that any user is not logged in, the controller 11 requires the user authentication in the pull scan.

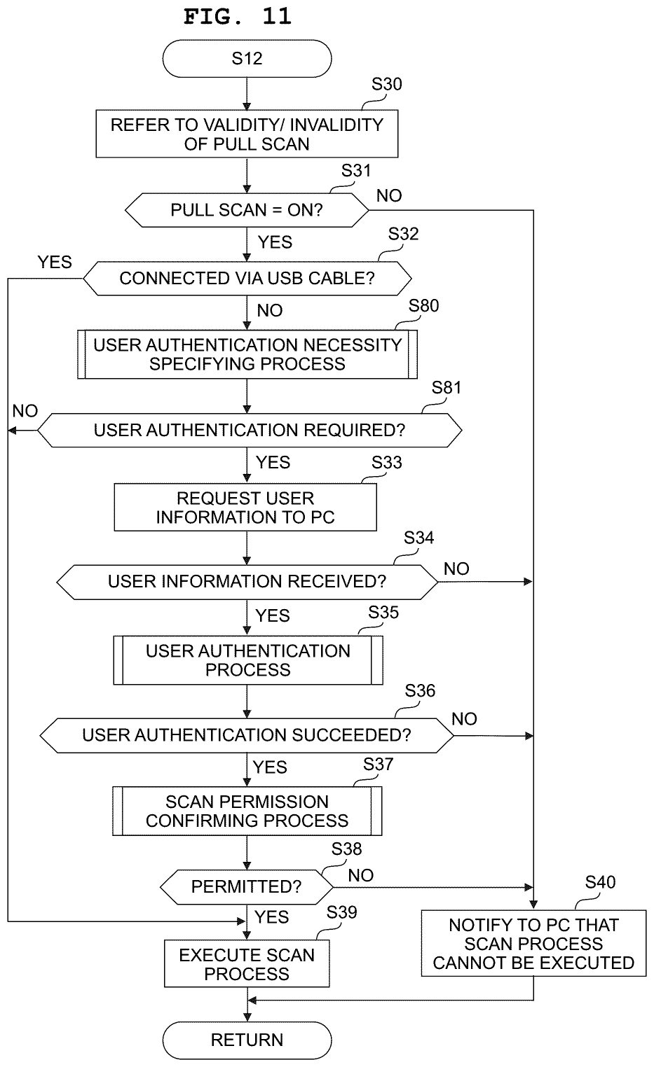

FIG. 11 is a flowchart describing the procedure of a process to be executed by the controller 11 in S12 in the second embodiment. Also in the second embodiment, the controller 11 executes the processes in S30 to S32, which have already been described in the foregoing. In S80, the controller 11 executes a user authentication necessity specifying process. By the user authentication necessity specifying process, the controller 11 uses the restriction setting value corresponding to the push scan in the “Public Mode” to specify whether or not the user authentication is required for the executing instruction of the pull scan.

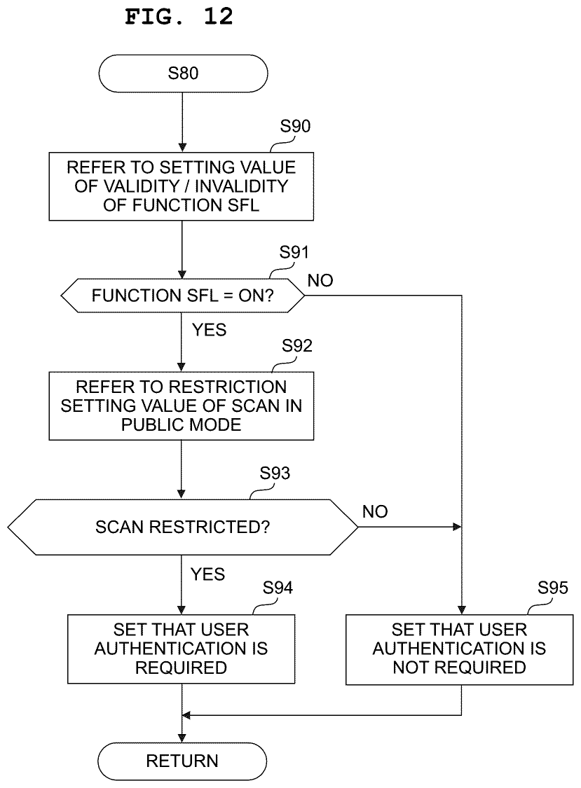

FIG. 12 is a flowchart describing the procedure of the process to be executed by the controller 11 in S80 of FIG. 11. First, the controller 11 refers to the column 19A of the SFL database 19 in S90. For example, in the SFL database 19 depicted in FIG. 5, the function “SFL” is validated (S91: YES); in this case, the controller 11 proceeds to S92 and refers to the restriction setting value corresponding to the function “Scan” in the “Public Mode” of the SFL database 19. Namely, the controller 11 refers to the column 19B of the SFL database 19 and determines as to whether or not the restriction setting value indicates the restriction of the push scan in the state that any user is not logged in (the no log-in state).

In this example, since the restriction setting value “Restricted” indicating the restriction is registered in the SFL database 19 depicted in FIG. 5 with respect to the function “Scan” in the “Public Mode” (S93: YES), the controller 11 proceeds to S94. In S94, the controller 11 sets that the user authentication is required with respect to the executing instruction of the pull scan. For example, the controller 11 sets a necessity determining flag to a value indicating that the user authentication is required.

The controller 11 proceeds to S81 in FIG. 11; since the necessity determining flag is set to the value indicating that the user authentication is required, namely, since the user authentication is required (S81: YES), the controller 11 proceeds to S33. Then, as described in the foregoing, the controller 11 performs the GET request with respect to the PC 40 so as to request the user information which is necessary for the user authentication. Then, the controller 11 executes the user authentication process in S35 described in the foregoing; in a case where the user authentication succeeds in S36 (S36: YES), the controller 11 proceeds to S37. Note that the processes of S37 to S40 executed by the controller 11 have already been described in the foregoing. In a case where execution of the pull scan is permitted (S38: YES), the controller 11 proceeds to S39 and executes the scan process (pull scan).

Next, a description will be given about a case where the pull scan is executed in a case where the restriction setting value “Permitted” which does not indicate the restriction with respect to the function “Scan” in the “Public Mode” is registered in the column 19B, unlike the SFL database 19 depicted in FIG. 5. Also in this example, the controller 11 executes the processes of S30 to S32 in FIG. 11 which have already been described.

In S80, the controller 11 executes the user authentication necessity specifying process as described already in the foregoing. Since in S91 of FIG. 12, the function “SFL” is validated “ON” (S91: YES) in the SFL database 19, the controller 11 proceeds to S92 and refers to the restriction setting value of the function “Scan” in the “Public Mode”. In this example, since the restriction setting value “Permitted” is registered with respect to the function “Scan” in the “Public Mode” (S93: NO) in the SFL database 19, the controller 11 proceeds to S95. In S95, the controller 11 sets a flag indicating that user authentication is not required with respect to the executing instruction of the pull scan.

In S81 of FIG. 11, since the user authentication is not required (S81: NO), the controller 11 proceeds to S39 and executes the scan process (pull scan) as already described. Namely, in a case where the push scan in the “Public Mode” is not restricted and where the controller 11 receives the executing instruction to perform the pull scan, the controller 11 executes the pull scan in S39, without executing the user authenticating process in S35.

Next, a description will be given about an example in which the function “SFL” is set to be invalidated “OFF” in the SFL database 19. As already described, in a case where the controller 11 determines in S91 of FIG. 12 that the function “SFL” is set to be invalidated “OFF” in the SFL database 19 (S91: NO), the controller 11 proceeds to S95 and sets that the user authentication is not required with respect to the executing instruction of the push scan. The controller 11 sets the necessity determining flag to a value indicating that user authentication is not required. In S81 of FIG. 11, since the user authentication is not required (S81: NO), the controller 11 proceeds to S39 and executes the scan process (pull scan). Namely, in this example, since the function “SFL” is invalidated, any restriction is not imposed on anyone, and the controller 11 executes the pull scan, without requiring the user authentication, in a case where the controller 11 receives the executing instruction of the pull scan.

In the second embodiment as described above, in the case where the controller 11 receives the executing instruction of the pull scan from the PC 40, the controller 11 specifies that the user authentication is required, under a condition that the restriction setting value “Restricted” indicating that the push scan in the “Public Mode” which is the state that any user is not logged in is restricted is registered in the SFL database 91. On the other hand, in a case where the restriction setting value “Permitted” indicating that the push scan in the “Public Mode” is not restricted is registered in the SFL database 19, the controller 11 specifies that the user authentication is not required. In the case where the restriction setting value “Permitted” is set in the “Public Mode”, the push scan is set to be permitted with respect to any user; accordingly, in such a case, the controller 11 is configured not to require the user authentication of the pull scan. On the other hand, in the case where the restriction setting value “Restricted” is set in the “Public Mode”, since there is provided a state that the security with respect to the MFP 10 is high, the controller 11 is configured to require the user authentication of the pull scan in such a case.

### Modification of Second Embodiment

In the above-described second embodiment, in the case where the restriction setting value “Restricted” is registered in the SFL database 19, with respect to the function “Scan” in the “Public Mode”, namely, with respect to the push scan in the state that any user is not logged in (S93: YES), the controller 11 requires the user authentication in the pull scan. Instead of this, the controller 11 may require the user authentication in the pull scan, in a case where the restriction setting value “Restricted” is registered, in the SFL database 19 to which the controller 11 refers in S92, with respect to the function “Scan” corresponding to all the registered users (S93: YES). Further, the controller 11 may require the user authentication in the pull scan, in a case where the restriction setting value “Restricted” is registered, in the SFL database 19 to which the controller 11 refers in S92, with respect to the function “Scan” for a predetermined specific user (S93: YES).

### Other Embodiments

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above-described embodiments, in a case where the “Secure Function Lock” is selected in the Web page 20 depicted in FIG. 3, the restriction setting values each of which indicates the restriction of one of the respective functions is set, by using the restriction setting screen 30 depicted in FIG. 4. Instead of this, also in a case where in the Web page 20 as depicted in FIG. 3, the check box 24C of the item “Active Directory Authentication”, or the check box 24D of the item “LDAP Authentication”, is checked, the restriction setting screen 30 depicted in FIG. 4 may be used to set the restriction setting values each of which indicates the restriction on one of the respective functions, and to enable executing of the processes of FIGS. 6 to 12. In a case where the check box 24C is checked and where the “Active Directory Authentication” is validated, the controller 11 may perform the log-in authentication to the MFP 10 based on the authentication information stored in an Active Directory (a registered trademark of Microsoft Corporation) server. The controller 11 may cause the Active Directory server to store the restriction setting values and use the restriction setting values in the processes depicted in FIGS. 6 to 12. In a case where the check box 24D is checked and where the “LDAP Authentication” is validated, the controller 11 may perform the log-in authentication to the MFP 10 based on the authentication information stored in a LDAP (Lightweight Directory Access Protocol) server. The controller 11 may cause the LDAP server to store the restriction setting values and use the stored restriction setting values in the processes depicted in FIGS. 6 to 12. Further, the authentication information and the restriction setting values may be stored, respectively, in different storage parts. For example, the controller 11 may perform the log-in authentication with respect to the MFP 10 based on the authentication information stored in the server, cause the SFL database 19 of the memory 12 to store the restriction setting values, and use the restriction setting values in the processes of FIGS. 6 to 12.

In the above-described embodiment, the controller 11 requests the PC 40 for the user information in S33 of FIG. 8, and executes the user authentication process in S35 by using the user information inputted from the PC 40 via the communication I/F 18. Instead of or in addition to the processes in S33 and S34, the controller 11 may perform the user authentication process in S35 by using the user information inputted by the user operating the user I/F 16. In this case, the user may input, as the user information, information issued by the controller 11 and notified to the user I/F 16 and/or the PC 40 in a case where the controller 11 receives the executing instruction of executing the scan and/or information notified in advance to persons or parties concerning utilizing the MFP 10. The user information may be a signal obtained by the operation of the keys of the user I/F 16 by the user in a specified order, other than the password.

In the above-described embodiments, the restriction setting value in the function “SFL” is set by using the Web page (home screen 20) transmitted from the controller 11 of the MFP 10. Instead of this, the restriction setting values in the function “SFL” may be set by operating the user I/F 16 of the MFP 10.

In S10 of FIG. 6, in the case where the controller 11 has received the executing instruction of the push scan by the operation with respect to the user I/F 16 (S10: YES), the controller 11 may proceed to S29 of FIG. 7 and execute the push scan. In this case, the processes of S20 to S28 in FIG. 7 are not executed.

Although the MFP 10 has been described as an example of the reading apparatus, the reading apparatus may be an apparatus capable of performing only the function “Scanner”.

What is claimed is:

1. A reading apparatus comprising:
a user interface;
a communication interface;
a scanner; and
a controller configured to execute a first scan of causing the scanner to read a document in response to an instruction to execute the first scan based on an operation to the user interface, and a second scan of causing the scanner to read a document in response to an instruction to execute the second scan from an external apparatus connected to the reading apparatus via the communication interface,
wherein the controller is configured to:
execute the first scan without requiring authentication in a case where the controller receives, via the user interface, the instruction to execute the first scan; and
perform the authentication in a case where the controller receives, via the communication interface, the instruction to execute the second scan, and then execute the second scan in a case where the authentication succeeds and not execute the second scan in a case where the authentication fails.

2. The reading apparatus according to claim 1, wherein in the case where the controller receives the instruction to execute the second scan via the communication interface, the controller is configured to require authentication information to the external apparatus, and to perform the authentication by using the authentication information obtained from the external apparatus.

3. The reading apparatus according to claim 1, wherein:
the controller is configured to set a restriction setting value regarding a restriction of a scan; and
in a case where the controller receives the instruction to execute the first scan via the user interface and where the restriction setting value indicates a restriction of the first scan, the controller is configured to restrict the first scan in accordance with the restriction setting value.

4. The reading apparatus according to claim 1, wherein the controller is configured to:
set a restriction setting value regarding a restriction of a scan in a manner that the restriction setting value is correlated to a user; and
execute the authentication based on user information included in the instruction to execute the second scan,
execute the second scan in a case where the restriction setting value does not indicate that the first scan is restricted with respect to the user indicated by the user information and where a condition for succeeding the authentication is satisfied, and
restrict the second scan in a case where the restriction setting value indicates that the first scan is restricted with respect to the user indicated by the user information even if the condition for succeeding the authentication is satisfied.

5. The reading apparatus according to claim 1, wherein the controller is configured:
to set a restriction setting value regarding a restriction of a scan in a manner that the restriction setting value is correlated with a no log-in state;
to require the authentication in a case where the controller receives the instruction to execute the second scan and where the restriction setting value indicates that the first scan in the no log-in state is restricted; and
not to require the authentication in a case where the controller receives the instruction to execute the second scan and where the restriction setting value does not indicate that the first scan in the no log-in state is restricted.

6. The reading apparatus according to claim 1, wherein the controller is configured to:
set a plurality of restriction setting values each regarding a restriction of a scan in a manner that the plurality of restriction setting values are correlated to a plurality of users, respectively; and
require the authentication, in a case where the controller receives the instruction to execute the second scan and where all of the plurality of restriction setting values indicates that the first scan is restricted or a restriction setting value, of the plurality of restriction setting values, corresponding to a predetermined user, of the plurality of users, indicates that the first scan is restricted.

7. The reading apparatus according to claim 1, wherein:
the communication interface is an interface configured to be connected to the external apparatus via an USB cable; and
the controller is configured to execute the second scan without requiring the authentication in a case where the controller receives the instruction to execute the second scan from the external apparatus via the USB cable.

8. A reading method executed by a controller of a reading apparatus including a user interface, a communication interface, a scanner and the controller, the controller being configured to execute a first scan of causing the scanner to read a document in response to an instruction to execute the first scan based on an operation to the user interface, and a second scan of causing the scanner to read a document in response to an instruction to execute the second scan from an external apparatus connected to the reading apparatus via the communication interface,
the reading method comprising:
executing the first scan without requiring authentication in a case where the controller receives, via the user interface, the instruction to execute the first scan, and
performing the authentication in a case where the controller receives, via the communication interface, the instruction to execute the second scan, and then executing the second scan in a case where the authentication succeeds and not executing the second scan in a case where the authentication fails.

9. A non-transitory and computer-readable medium storing a program executable by a controller of a reading apparatus including a user interface, a communication interface, a scanner and the controller, the controller being configured to execute a first scan of causing the scanner to read a document in response to an instruction to execute the first scan based on an operation to the user interface, and a second scan of causing the scanner to read a document in response to an instruction to execute the second scan from an external apparatus connected to the reading apparatus via the communication interface,
the program is configured to cause the controller to:
execute the first scan without requiring authentication in a case where the controller receives, via the user interface, the instruction to execute the first scan, and
perform the authentication in a case where the controller receives, via the communication interface, the instruction to execute the second scan, and then execute the second scan in a case where the authentication succeeds and not execute the second scan in a case where the authentication fails.
